(19) United States
(12) Patent Application Publication
(10) Pub. No.: US 2014/0337424 A1
(43) Pub. Date: Nov. 13, 2014

(54) Authorizing Push Notifications for Websites

(71) Applicant: Apple Inc., Cupertino, CA (US)

(72) Inventors: Jonathan J. Lee, San Francisco, CA (US); Brian A. Weinstein, San Jose, CA (US); Samuel M. Weinig, Sunnyvale, CA (US); Steven Jon Falkenburg, Los Altos, CA (US)

(73) Assignee: Apple Inc., Cupertino, CA (US)

(21) Appl. No.: 13/891,983

(22) Filed: May 10, 2013

(51) Int. Cl. H04L 29/08

(52) U.S. Cl. CPC H04L 67/26
USPC 709/204

(57) ABSTRACT

In some implementations, a website can be certified by a push notification service operator to send push notifications to user devices. A web browser on the user's device can communicate with the website to advertise the user device's ability to receive push notifications. The website can provide to the web browser a certificate indicating that the website is authorized to utilize the push notification service. If the certificate is valid and has not been revoked, the browser can prompt the user to allow push notifications from the website. If the user authorizes push notifications, a device token can be provided to the website that allows the website to send push notifications to the user device through the push notification service. In some implementations, the web browser can be configured to provide websites access to APIs for accessing information stored on a user device.

### TECHNICAL FIELD

The disclosure generally relates to mechanisms for providing push notifications to user devices.

### BACKGROUND

Often application developers will create applications for a mobile device (e.g., smartphone, tablet computer, etc.) that can be installed on the mobile device to provide access to online content. The application can be vetted by an approval authority before users are allowed to download the application to their mobile devices. Once the application has been approved, the application can be downloaded and installed on user devices. The approval of the application by the approval authority can provide implicit authorization for the application to perform various operations on the user's device. For example, an approved application can request approval from the user for a server associated with the vendor of the application to send push notifications to the user's device.

While the application developer may generate an application for a mobile device, often developers will just provide a website for other computing devices (e.g., desktop computers, laptop computers, etc.) and allow the user to view the website through a web browser installed on the user's computing device. Since the website doesn't get vetted or approved in the same way as an application, the website does not have the same implicit authorization as the application to perform operations on the user's computing device. For example, the website through the browser cannot currently request approval from the user to send push notifications to the user's computing device. Thus, there is currently no way for the user to authorize a website to provide push notifications to the user's computing device.

### SUMMARY

In some implementations, a push notification provider can be certified by a push notification service operator to send push notifications to user devices. A web browser on the user's device can communicate with the website to receive a location (e.g., network address, URL) where the browser can download a push notification certificate for the push notification provider. The web browser can download a certificate indicating that the push notification provider is authorized to utilize the push notification service. If the certificate is valid and has not been revoked, the browser can prompt the user to allow push notifications from the push notification provider. If the user authorizes push notifications, a device token can be provided to the push notification provider that allows the push notification provider to send push notifications to the user device through the push notification service. In some implementations, the web browser can be configured to provide websites, push notification providers and/or other entities access to APIs for accessing information stored on a user device.

Particular implementations provide at least the following advantages: Websites can be authorized to provide push notifications to a user device. A web browser can be used to prompt the user to approve push notifications from a website.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example system for authorizing push notifications for websites.

FIG. 2 is an example graphical user interface for requesting a user to approve push notifications from a website.

FIG. 3 is an example graphical user interface for presenting a push notification on a user device.

FIG. 4 is an example graphical user interface for revoking authorization for a website to send push notifications to a user device.

FIG. 5 is a flow diagram of an example process performed by a user device for authorizing push notifications for websites.

FIG. 6 is a flow diagram of an example process performed by a vendor website for receiving authorization to send push notifications to a user device.

FIG. 7 is a flow diagram for an example process performed by a website for authorizing access to a browser API at a user device.

FIG. 8 is a block diagram of an exemplary system architecture implementing the features and processes of FIGS. 1-7.

Like reference symbols in the various drawings indicate like elements.

### DETAILED DESCRIPTION

### Overview

Push notifications allow an approved vendor (e.g., application developer, website operator, etc.) to send notifications to a user device (e.g., mobile device, computer, etc.) through a push notification service. The vendor can be approved by the operator of the push notification service or some other approval authority. The approval of the vendor can be implicit. For example, the approval authority can approve an application developed by the vendor for installation on a user device. The approval of the application can provide implicit approval for the vendor to send push notifications to the user's device. Once the application has been installed on the user's device, the application can request approval from the user to send push notifications to the user's device. Thus, the approval of the application by the approval authority and the installation of the application on the user's device provides authorization to the application vendor to use the approved application to request permission from the user to provide push notifications to the user's device.

Push notifications are different than application notifications. For example, a web browser can be configured to present notifications received from vendor websites. The website can, through the browser user interface, request permission from the user to present application notifications and subsequently present notifications through the web browser. However, the notifications can only be presented to the user while the browser application is running or executing on the user's device. The application notifications are delivered to a running application. In contrast, push notifications are delivered to the device (e.g., an operating system notification service of the device); no application need be running to receive and present the notification. There is currently no mechanism for websites to get authorization from a user to present push notifications to the user's device.

### System for Authorizing Push Notifications for Websites

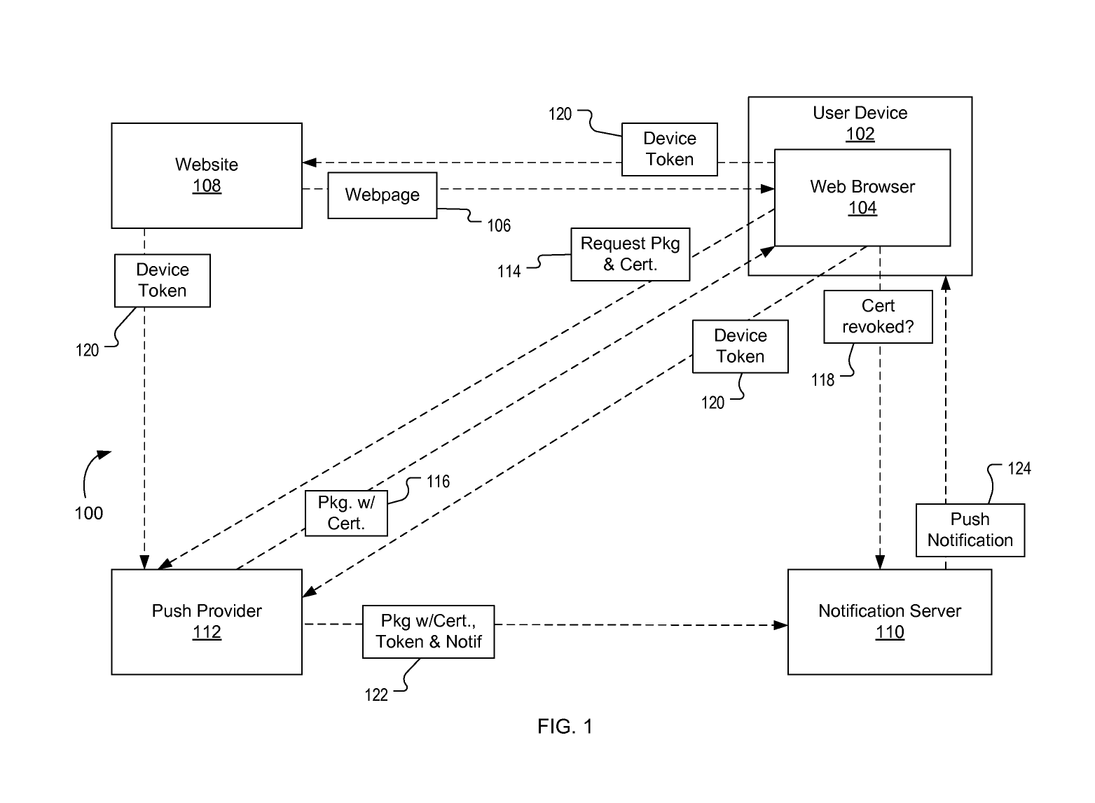

FIG. 1 illustrates an example system 100 for authorizing push notifications for websites. In some implementations, system 100 can include user device 102 running web browser 104. For example, a user operating user device 102 can invoke a web browser application 104 on user device 102. The user can operate web browser 104 to download and display a webpage 106 provided by website server 108. For example, if website server 108 hosts the website “Really Cool Stuff” at “www.reallycoolstuff.com”, then the user can enter or select the website's URL “www.reallycoolstuff.com” at the web browser 104 to download and view a webpage 106 of the website from web server 108 on the user interface of web browser 104.

In some implementations, user device 102 can be configured to receive push notifications. For example, the operating system of user device 102 can include a push notification client that can receive push notifications from push notification server 110 (i.e., push notification service 110). When the user operates web browser 104 to access a website or webpage 106 hosted by website server 108, the web browser 104 can download the webpage 106 which contains code (e.g., HTML, JavaScript, etc.) that indicates the website's desire to request permission for sending push notifications to the user device. For example, the webpage can include JavaScript that invokes a web browser API for requesting permission to send push notifications to the user's device. Within that code, the webpage 106 can provide a URL (e.g., through the API) that the web browser 104 can use to contact the push notification provider 112 and request a package of information containing a push notification certificate 114 for the website 108.

In some implementations, push notification provider 112 can send web browser 104 a message 116 that includes a certificate indicating that push notification provider 112 is authorized to send push notifications to user devices. For example, push notification provider 112 (e.g., the website operator) can be granted a push notification certificate by an approval authority (e.g., the operator of the push notification server 110). For example, in response to receiving message 114 from web browser 104 requesting the push notification provider's information package and certificate, push notification provider 112 can send message 116 including a package of information, including the push notification authorization certificate, to web browser 106. In some implementations, the package of information can include a display name, the website address (e.g., URL), a list of associated domains and/or a display image. The information in the package can be used to present notifications and prompts to the user, for example.

In some implementations, when web browser 104 receives the certificate from push notification provider 112, web browser 104 can validate the certificate. For example, web browser 104 can verify the certificate by comparing the certificate received from website server 106 to a root certificate issued by the approval authority (e.g., certificate authority) and distributed with web browser 104. In some implementations, web browser 104 can query notification server 110 (or another appropriate server) to determine if the certificate received from push notification provider 112 has been revoked. For example, web browser 104 can transmit a message 118 to notification server 108 requesting the revocation status of the website server's certificate. For example, message 118 can include the certificate received from push notification provider 112. Notification server 110 can respond to the web browser's revocation query by indicating in a message (not shown) to the web browser that the certificate has been revoked or has not been revoked. For example, the notification server can compare the push notification provider 112 certificate to a certificate revocation list stored at notification server 108 to determine if the certificate has been revoked.

In some implementations, web browser 104 can display a prompt to the user asking the user if the user would like to receive push notifications from website server 106. For example, once the certificate received from push provider 112 has been validated and/or confirmed to be active (e.g., not revoked) and if the domain associated with website 108 is in the domain list provided by push provider 112, web browser 104 can display the prompt requesting that the user allow push notifications from push provider 112 to user device 102. The information displayed on the prompt (e.g., website name, image associated with website, etc.) can be obtained from the package of information received in message 116.

In some implementations, when the user provides input allowing push notifications from push notification provider 112 to user device 102, web browser 104 can transmit a message that includes a device token 120 to website server 108. For example, the device token 120 can include information that identifies user device 102 and/or information that can be used by notification server 110 to route push notifications to user device 102. For example, the device token 120 can include information that notification server 110 can use to identify user device 102. The device token 120 can be generated in a way that prevents reading or deciphering the contents of the device token by devices other than notification server 110. For example, the information in the device token 120 can be encrypted using an encryption key only known to notification server 110.

In some implementations, website server 108 can transmit the received device token 120 to push notification provider 112 so that push notification provider 112 can use the device token 120 to send push notifications to user device 102. In some implementations, instead of or in addition to sending the device token 120 to website 108, the web browser 104 can send the device token 120 directly to push notification provider 112.

In some implementations, push notification provider 112 can use the received device token to send push notifications to user device 102. For example, push notification provider 112 can generate a message 122 that includes a package of information about website 108 and/or push notification provider 112 (e.g., including the push notification certificate for website server 106), the device token 120 received from user device 102 and a notification to be displayed on user device 102. The package of information can be the same package of information that was sent to web browser 104 in message 116, as described above. Push notification provider 112 can transmit message 122 to notification server 110.

In some implementations, upon receipt of message 122, notification server 110 can verify the certificate for push notification provider 112. For example, notification server 110 can compare the certificate to a root certificate to determine if the certificate is valid. Notification server 110 can compare the website certificate to a certificate revocation list to determine if the certificate has been revoked. If the certificate is valid and has not been revoked, notification server 110 can identify user device 102 based on the device token and transmit the package of information for website server 108 and/or push notification provider 112 and the push notification to user device 102. For example, notification server 110 can send message 124 that includes the package of information and the push notification to the push notification client on user device 102.

Because the notification is a push notification, the notification is sent to the device instead of being sent to an application running on the device. For example, the push notification can be sent to an operating system service (e.g., push notification client) that handles push notifications. The push notification is not sent to the web browser application 104 or any other application running on user device 102. The web browser application 104 does not need to be running or executing on user device 102 for user device 102 to receive and display push notifications.

In some implementations, user device 102 can receive the package of information for website server 108 and/or push provider 112 and the push notification from notification server 110. For example, user device 102 can receive message 124. In response to receiving message 124, user device 102 can present the push notification on a graphical user interface of user device 102. For example, a notification popup can be presented on a desktop user interface of user device 102. The notification popup can be a small window, bubble, callout or other graphical element that can be used to present the push notification to the user. The push notification popup can present a display name associated with the website server 108 (e.g., the website) and/or push notification provider 112, an image associated with the website 108 and/or push notification provider 112, and a message or other content specified by the website server 108 and/or push notification provider 112. The information displayed on the notification popup can be obtained from the package of information for the website server 108, push notification provider 112 and/or from the push notification sent by the push notification provider 112.

In some implementations, other websites and/or servers associated with push notification provider 112 can request user permission to send push notifications on behalf of push notification provider 112. For example, the package of information transmitted by push notification provider 112 to web browser 104 can include a list of allowed domains (e.g., other websites, servers, etc.). If a server or website with an address (e.g., URL) associated with one of the listed domains attempts to request user permission from web browser 104 to send push notifications to user device 102, web browser 104 can recognize the domain associated with the address as an allowed domain associated with a certified or approved push notification provider and present a prompt to the user requesting permission to allow the push notification provider and/or website to send push notifications to the user device.

### Graphical User Interfaces

This disclosure describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radial buttons, checkboxes and any other mechanism for receiving input from, or providing feedback to a user.

### Web Browser Prompt to Allow Push Notifications

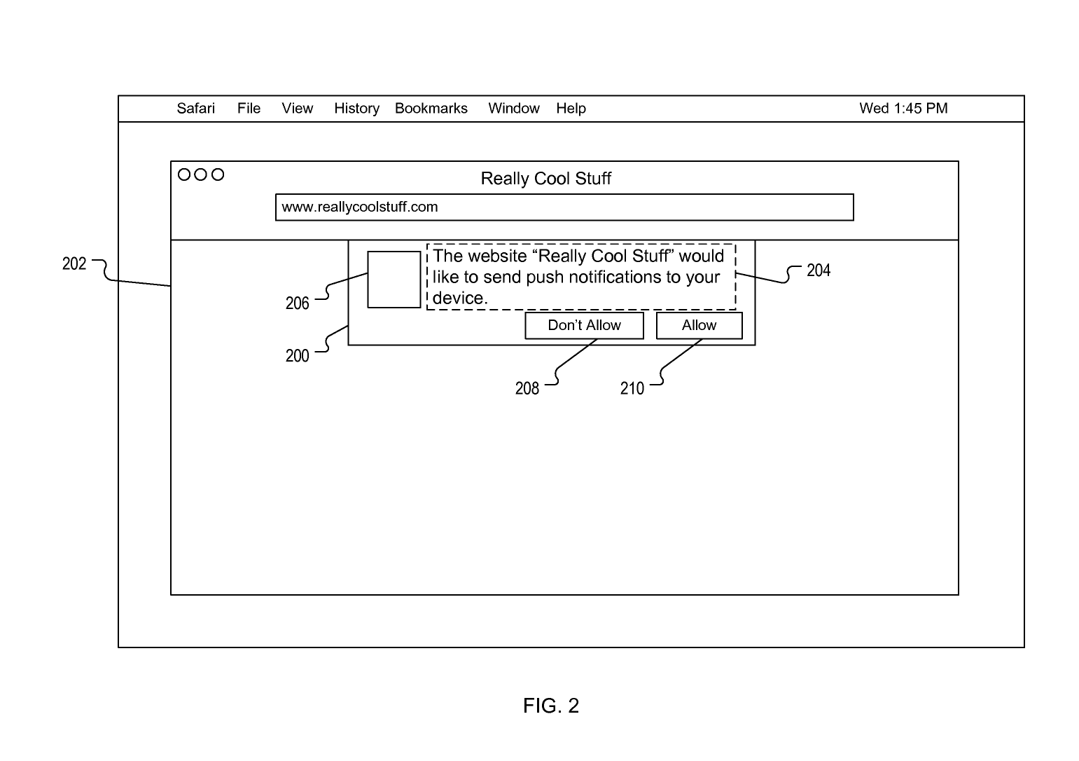

FIG. 2 is an example graphical user interface 200 for requesting a user to approve push notifications from a website. For example, graphical user interface 200 can be a user interface that pops up, slides into view or is otherwise presented on or over web browser graphical user interface 202. For example, a user can provide input to web browser GUI 202 to cause the web browser to navigate to and display a web page associated with a website (e.g., www.reallycoolstuff.com). The web browser can send the website (e.g., website server) a message advertising the push notification service available on the user's device. The website can send to the web browser a certificate indicating that the website has been approved for sending push notifications by a push notification certificate authority. The website can also send a package of information associated with the website (e.g., display name, image, etc.).

In some implementations, GUI 200 can be presented in response to the web browser receiving a certificate authorizing a push notification provider to send push notifications to a user computing device. For example, the web browser can download a webpage that includes code that invokes an API for presenting a push notification authorization request to the user. The webpage can specify a URL for downloading a certificate authorizing a push notification provider to send push notifications. The browser can receive a push notification certificate from the push notification provider, validate the certificate and present GUI 200 when the certificate is determined to be valid, as described above with reference to FIG. 1.

In some implementations, GUI 200 can present information received from the push notification provider. For example, GUI 200 can present a message 204 including the display name for the push notification provider (or website) and prompting the user to allow push notifications from the push notification provider. GUI 200 can present an image 206 representing the push notification provider. For example, the display name and the image can be obtained from the package of information received from the push notification provider as described with reference to FIG. 1.

In some implementations, the user can select to allow or disallow push notifications from the push notification provider. For example, the user can select graphical element 208 (e.g., a button) to prevent the push notification provider from sending push notifications to the user's device. Alternatively, the user can select graphical element 210 to allow the push notification provider to send push notifications to the user's device. In some implementations, the web browser will send a device token that identifies the user's device to the website in response to the user's selection to allow the push notification provider to send push notifications to the user's device. For example, receipt of the device token by the push notification provider and/or website provides a mechanism for the push notification provider to send push notifications to the user's device.

### Displaying a Push Notification

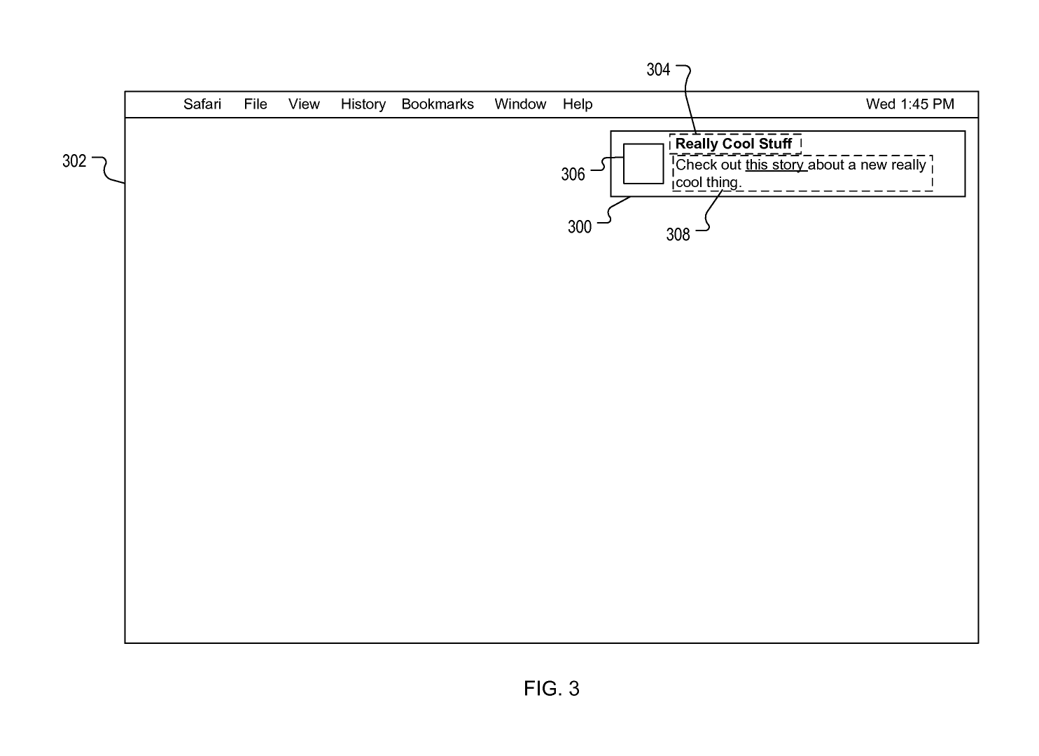

FIG. 3 is an example graphical user interface 300 for presenting a push notification on a user device. For example, GUI 300 can be presented on operating system GUI 302 (e.g., desktop GUI). GUI 300 can present a push notification sent by a user-approved push notification provider to the user's device. For example, the push notification provider can send the push notification to a push notification server. If the push notification server determines that the push notification provider has been certified for sending push notifications, then the push notification server can send the push notification to a user device identified by a device token sent to the push notification server from the push notification provider. When the user device receives the push notification, the user device can present the push notification on a user interface of the user device. For example, the user device can receive a push notification and/or a package of information associated with the push notification provider or website. The push notification and/or the package of information can include a display name for the push notification provider, an image representing the push notification provider, a notification message, and/or a link (e.g., URL) to content at a website, for example. GUI 300 can be configured to present the display name 304 (e.g., “Really Cool Stuff”), the image 306, and the notification message 308.

In some implementations, the push notification can provide a link (e.g., URL) to content at a website. For example, when a user selects GUI 300, a web browser can be invoked with the URL as a parameter to the invocation. The web browser can open the webpage associated with the URL so that the user can view content referenced by the push notification presented by GUI 300. In some implementations, GUI 300 can be removed from the display once GUI 300 is selected by the user. In some implementations, GUI 300 can be removed from the display once a specified period of time has elapsed since GUI 300 was first presented.

### De-Authorizing Push Notifications

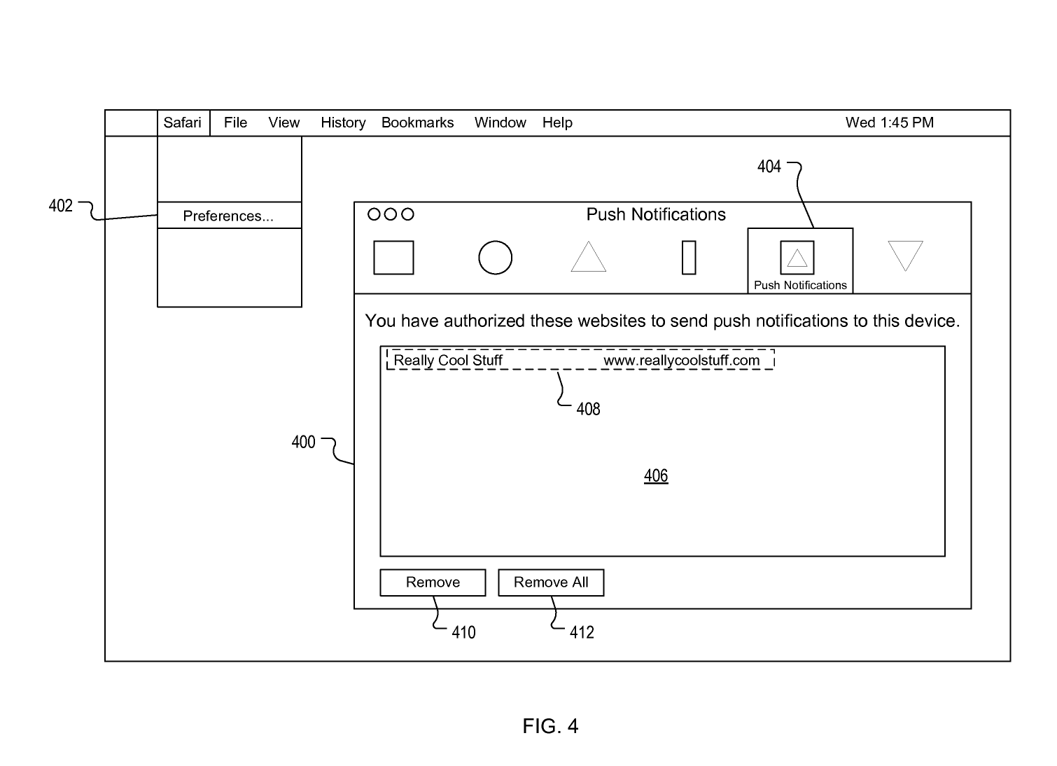

FIG. 4 is an example graphical user interface 400 for revoking authorization for a push notification provider to send push notifications to a user device. For example, GUI 400 can be invoked in response to a user selecting web browser preferences menu item 402 and/or push notification tab 404. In some implementations, GUI 400 can include area 406 that can include a list of push notification providers (e.g., websites, website operators, etc.) that the user has authorized to send push notifications to the user's device. For example, if the user has previously authorized the website “Really Cool Stuff” to send push notifications to the user's device, the website “Really Cool Stuff” can be identified in area 406.

In some implementations, a user can select a push notification provider listed on GUI 400 and revoke the selected push notification provider's authorization to send push notifications to the user's device. For example, the user can select the authorized push notification provider 408 and then select graphical element 410 (e.g., remove button) to remove push notification provider 408 from the list of authorized push notification provider. In some implementations, the user can select graphical element 412 to remove all push notification provider from the list of authorized push notification provider.

In some implementations, when a push notification provider is removed from the authorized list of push notification provider, the web browser can send a message to the removed push notification provider to inform the push notification provider that it is no longer authorized to send push notifications to the user's device. If the push notification provider ignores the de-authorization message and sends a subsequent push notification to the user's device, the push notification will not be displayed by the user device because the user device will compare the push notification provider associated with the push notification to the list of push notification provider currently approved for sending push notifications to the user device and prevent the presentation of push notifications received from push notification providers that are not in the approved push notification provider list.

### Example Processes

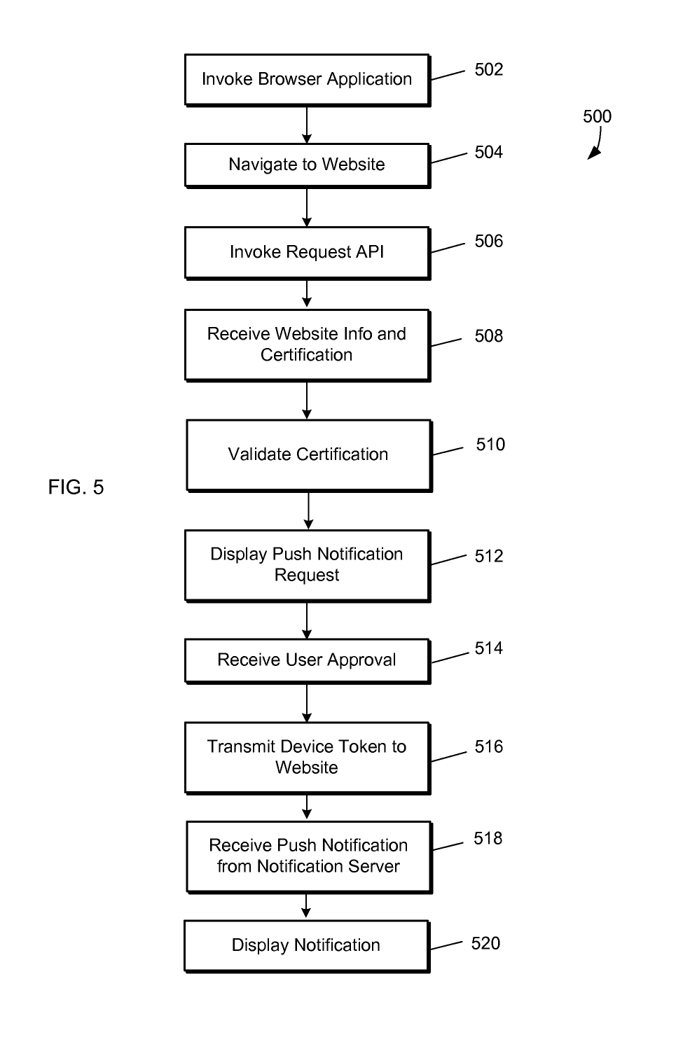

FIG. 5 is a flow diagram of an example process 500 performed by a user device for authorizing push notifications for push notification provider. At step 502, the user can invoke a web browser application. For example, the user can invoke the web browser application on a user device such as a desktop computer, laptop computer, or any other computing device.

At step 504, the user can navigate to a website using the web browser. For example, the user can specify a web address or select a link to a web address (e.g., www.reallycoolstuff.com) to cause the browser to display a web page associated with the specified address.

At step 506, the web browser can determine that the webpage includes an invocation of an API for triggering a push notification authorization request. For example, the webpage can include code (e.g., HTML, JavaScript, etc.) that invokes a browser API that can cause a prompt to be presented to the user requesting that the user authorize push notifications for a push notification provider associated with the webpage.

At step 508, the web browser can receive a package containing information about the website and a certificate authorizing the website to send push notifications. For example, the website code can include a URL that the browser can use to download or request a push notification certificate from the push notification provider. The certificate can be granted to the push notification provider (e.g., an operator of the website) by an approval authority (e.g. the push notification service operator). The certificate can indicate that the push notification provider is trusted to not abuse the push notification service.

At step 510, the web browser can validate the push notification provider's certificate. For example, the web browser can be distributed with a root certificate from the operator of the push notification service. The web browser can compare the push notification provider's certificate to the root certificate provided by the approval authority (i.e., certificate authority) to determine if the push notification provider's certificate is valid. In some implementations, the web browser can contact a server hosting a certificate revocation list to request the revocation status of the push notification provider's certificate. In some implementations, the web browser can compare the website's domain to the list of domains specified by the push notification provider to determine of the website is authorized to request user authorization for push notifications.

At step 512, the web browser can display a push notification request on a user interface of the web browser. For example, the web browser can present a prompt to the user asking the user if the user would like to allow (or disallow) push notifications from the website in response to the web browser determining that the website's certificate is valid, the certificate has not been revoked and that the website domain is authorized to request authorization for push notifications.

At step 514, the web browser can receive the user's approval to allow push notifications from the push notification provider. For example, the user can select a button to allow (or disallow) push notifications from the push notification provider.

At step 516, the web browser can transmit a device token to the website and/or push notification provider. For example, when the user allows push notifications to be sent to the user's device from the push notification provider, the web browser can send a device token that can be used to identify the user's device to the website and/or push notification provider. For example, if the device token is sent to the website, the website can transmit the device token to the push notification provider. If the user does not allow push notifications from the push notification provider, the device token will not be sent to the push notification provider; thus, the push notification provider will have no mechanism to send push notifications to the user's device.

At step 518, the user's device can receive a push notification originated at the push notification provider from a notification server. For example, once the push notification provider receives the device token, the push notification provider can send the device token along with a push notification message to the notification server. The notification server can determine a device to send the push notification message to based on the device token. For example, the notification server can maintain a repository of information that maps device tokens to user devices. Alternatively, the device token can contain information that identifies the corresponding user device. The device token can be encrypted such that only the notification server can decrypt the token and identify the device corresponding to the device token. The notification server can then send the push notification to the user device identified by the device token. The push notification can then be received by the operating system push notification client at the user device.

At step 520, the user device can display the push notification. For example, the operating system of the user device can display the contents of the push notification in a graphical object displayed on the user's device, as illustrated by FIG. 3.

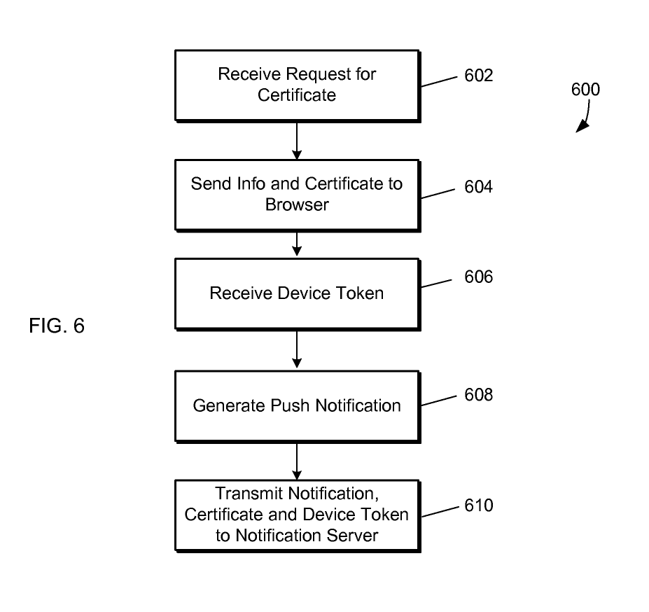

FIG. 6 is a flow diagram of an example process 600 performed by a push notification provider for receiving authorization to send push notifications to a user device. For example, a webpage of a website can be accessed and downloaded by a web browser running on a user device. The webpage can include a URL associated with the push notification provider that can be accessed by the web browser for downloading a push notification certificate for the push notification provider.

At step 602, the push notification provider can receive a request for the push notification provider's push notification certificate. For example, the web browser can use the URL encoded in the webpage to request the push notification provider's push notification certificate.

At step 604, the push notification provider can send a package of information associated with the push notification provider and including a certificate indicating that the push notification provider is authorized to send push notifications. For example, the push notification provider can send the certificate and information if the push notification provider is configured and authorized to send push notifications to user devices.

At step 606, the push notification provider can receive a device token from the web browser. For example, if the web browser determines that the push notification provider certificate is valid and has not been revoked, the web browser can send a device token that can be used to identify and send push notifications to the user device.

At step 608, the push notification provider can generate a push notification. For example, the push notification provider can generate a message containing text, images, URLs or other information to be displayed to the user on the user's device.

At step 610, the push notification provider can transmit the push notification, the push notification provider's certificate and the device token to a notification server. For example, the notification server can identify the user device that is the recipient of the push notification based on the device token. The notification server can validate the website certificate to determine whether the website is authorized to send push notifications. If the certificate is valid and the user device can be identified based on the device token, then the notification server will transmit the push notification to the user device identified by the device token.

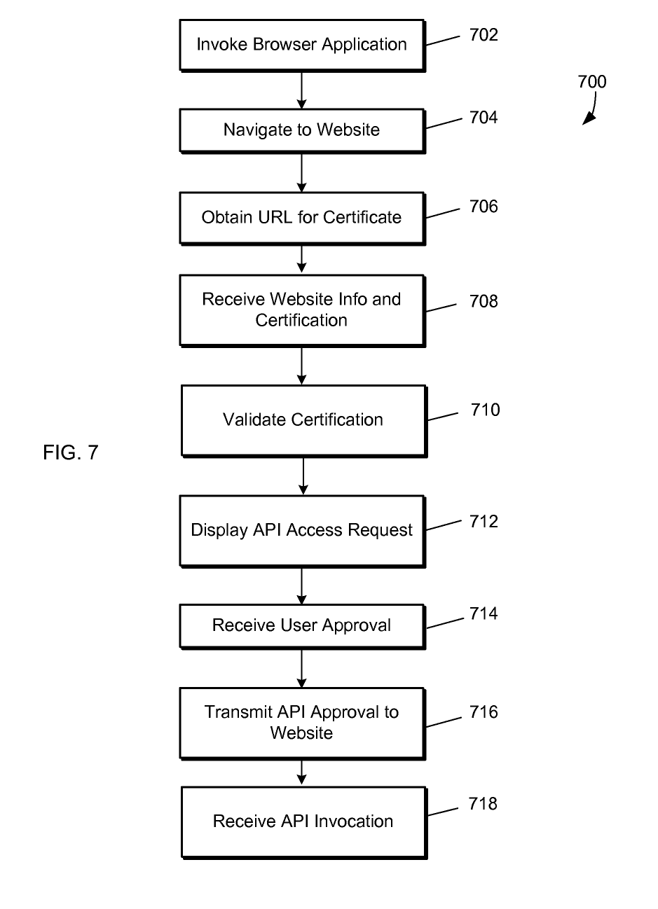

FIG. 7 is a flow diagram for an example process 700 performed by a web browser for authorizing access to an API at a user device. For example, the browser can provide an API for accessing information and/or services on a user device. The browser can provide an API for accessing contacts information, calendar information, notes, private files, reminders, to do lists, messages, emails or other information stored on the user's device, for example.

At step 702, the user can invoke a web browser application. For example, the user can invoke the web browser application on a user device such as a desktop computer, laptop computer, or any other computing device.

At step 704, the user can navigate to a website using the web browser. For example, the user can specify a web address or select a link to a web address (e.g., www.reallycoolstuff.com) to cause the browser to display a webpage associated with the specified address.

At step 706, the web browser can obtain a URL for downloading a certificate that authorizes the website to access an API of the user device. For example, the website may be trusted by a certificate authority associated with the user device's operating system to access one or more APIs of the user device.

At step 708, the web browser can use the URL to download a package containing information about the website and a certificate indicating that the website is trusted to access one or more web browser APIs for accessing information on the user's device. For example, the certificate can be granted to the website (or operator of the website) by a vendor (e.g., certificate authority) of the operating system (or web browser) of the user's device. The certificate can indicate that the website is trusted to not abuse the application programming interfaces (APIs) provided by the web browser or user device.

At step 710, the web browser can validate the website's certificate. For example, the web browser can be distributed with a root certificate from the vendor of the operating system. The web browser can compare the website's certificate to the root certificate to determine of the website's certificate is valid. In some implementations, the web browser can contact a server hosting a certificate revocation list to request the revocation status of the website's certificate.

At step 712, the web browser can display an API access request on a user interface of the web browser. For example, the web browser can present a prompt to the user asking the user if the user would like to allow (or disallow) the website to access one or more APIs for accessing information on the user's device once the website has determined that the website's certificate is valid and has not been revoked.

At step 714, the web browser can receive the user's approval to allow access to the requested API. For example, the user can allow the website to access an address book or contacts list on the user's device through an API provided by the web browser or the operating system of the user device.

At step 716, the web browser can transmit to the website the user's approval to access the requested API. For example, the web browser can transmit a message to the website indicating that the requested API is now available for use by the website.

At step 718, the web browser can receive an invocation of the requested API. For example, the website can transmit a web page to the web browser that includes a java script invocation of an API that allows access to information in an address book or contacts list stored on the user's device.

### Example System Architecture

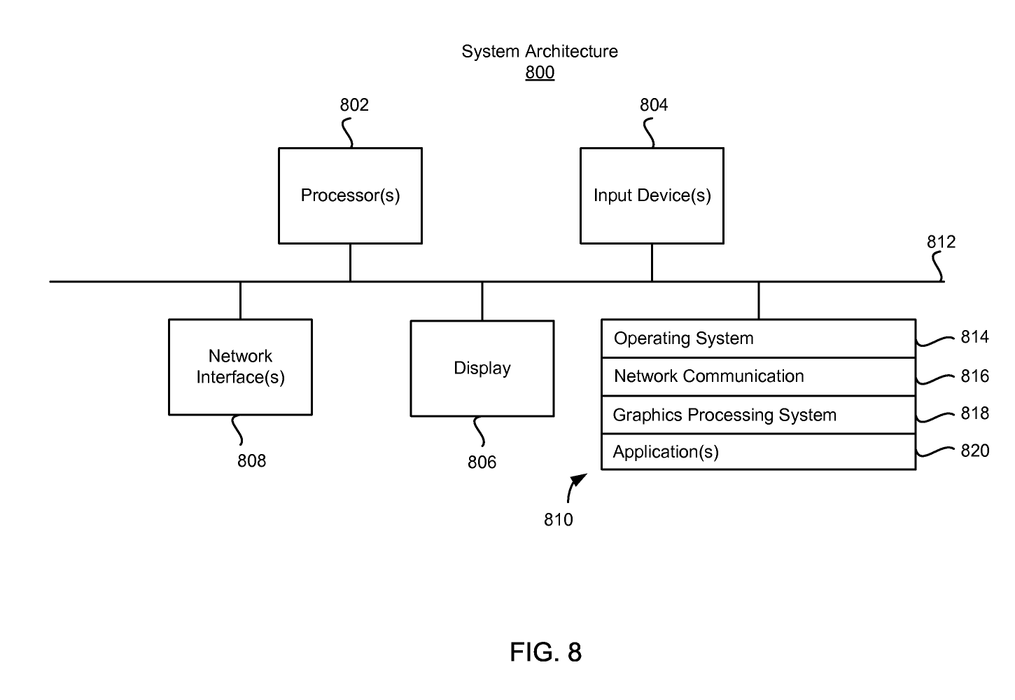

FIG. 8 is a block diagram of an exemplary system architecture implementing the features and processes of FIGS. 1-7. The architecture 800 can be implemented on any electronic device that runs software applications derived from compiled instructions, including without limitation personal computers, servers, smart phones, media players, electronic tablets, game consoles, email devices, etc. In some implementations, the architecture 800 can include one or more processors 802, one or more input devices 804, one or more display devices 806, one or more network interfaces 808 and one or more computer-readable mediums 810. Each of these components can be coupled by bus 812.

Display device 806 can be any known display technology, including but not limited to display devices using Liquid Crystal Display (LCD) or Light Emitting Diode (LED) technology. Processor(s) 802 can use any known processor technology, including but are not limited to graphics processors and multi-core processors. Input device 804 can be any known input device technology, including but not limited to a keyboard (including a virtual keyboard), mouse, track ball, and touch-sensitive pad or display. Bus 812 can be any known internal or external bus technology, including but not limited to ISA, EISA, PCI, PCI Express, NuBus, USB, Serial ATA or FireWire. Computer-readable medium 810 can be any medium that participates in providing instructions to processor(s) 802 for execution, including without limitation, non-volatile storage media (e.g., optical disks, magnetic disks, flash drives, etc.) or volatile media (e.g., SDRAM, ROM, etc.).

Computer-readable medium 810 can include various instructions 814 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 804; sending output to display device 806; keeping track of files and directories on computer-readable medium 810; controlling peripheral devices (e.g., disk drives, printers, etc.) which can be controlled directly or through an I/O controller; and managing traffic on bus 812. Network communications instructions 816 can establish and maintain network connections (e.g., software for implementing communication protocols, such as TCP/IP, HTTP, Ethernet, etc.).

A graphics processing system 818 can include instructions that provide graphics and image processing capabilities. For example, the graphics processing system 818 can implement the processes described with reference to FIGS. 1-7.

Application(s) 820 can be an application (such as a web browser) that uses or implements the processes described in reference to FIGS. 1-7. The processes can also be implemented in operating system 814. For example, some or all of the processes described with reference to FIGS. 1-7 can be implemented by one or more operating system services, such as the push notification client described above.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
receiving, at a web browser application executing on a computing device, a certificate associated with a push notification provider;
determining, by the web browser, that the certificate is valid;
in response to the determination, presenting a prompt on a user interface of the web browser requesting that a user approve receiving push notifications from the push notification provider;
receiving approval from the user for the website to send push notifications to the computing device; and
in response to receiving approval from the user, transmitting, from the web browser to the push notification provider, a device token that identifies the computing device to a push notification service.

2. The method of claim 1, wherein the certificate indicates that the push notification provider is trusted to send push notifications to user devices.

3. The method of claim 1, further comprising:
receiving, at an operating system service of the computing device, a push notification from a push notification server; and
displaying the push notification on a user interface of an operating system of the computing device.

4. The method of claim 1, further comprising:
downloading, by the web browser, a webpage of the website;
obtaining a network address from the webpage; and
downloading the certificate based on the network address.

5. A method comprising:
receiving, at a web browser application executing on a computing device, a certificate associated with a website;
determining, by the web browser, that the certificate is valid;
in response to the determination, presenting a prompt on a user interface of the web browser, the prompt requesting that a user allow the website to access a web browser API for accessing information on the computing device;
receiving approval from the user for the website to access the API; and
in response to receiving approval from the user, sending the website approval to access the API.

6. The method of claim 5, further comprising:
receiving, at the web browser, an invocation of the API from the website, the API allowing the website to access information stored on the computing device.

7. The method of claim 5, further comprising:
allowing, through the web browser, the website to access contacts information stored on the computing device through the API.

8. A non-transitory computer-readable medium including one or more sequences of instructions which, when executed by one or more processors, causes:
receiving, at a web browser application executing on a computing device, a certificate associated with a push notification provider;
determining, by the web browser, that the certificate is valid;
in response to the determination, presenting a prompt on a user interface of the web browser requesting that a user approve receiving push notifications from the push notification provider;
receiving approval from the user for the website to send push notifications to the computing device; and
in response to receiving approval from the user, transmitting, from the web browser to the push notification provider, a device token that identifies the computing device to a push notification service.

9. The non-transitory computer-readable medium of claim 8, wherein the certificate indicates that the push notification provider is trusted to send push notifications to user devices.

10. The non-transitory computer-readable medium of claim 8, wherein the instructions cause:
receiving, at an operating system service of the computing device, a push notification from a push notification server; and
displaying the push notification on a user interface of an operating system of the computing device.

11. The non-transitory computer-readable medium of claim 8, wherein the instructions cause:
downloading, by the web browser, a webpage of the website;
obtaining a network address from the webpage; and
downloading the certificate based on the network address.

12. A non-transitory computer-readable medium including one or more sequences of instructions which, when executed by one or more processors, causes:
receiving, at a web browser application executing on a computing device, a certificate associated with a website;
determining, by the web browser, that the certificate is valid;
in response to the determination, presenting a prompt on a user interface of the web browser, the prompt requesting that a user allow the website to access a web browser API for accessing information on the computing device;
receiving approval from the user for the website to access the API; and
in response to receiving approval from the user, sending the website approval to access the API.

13. The non-transitory computer-readable medium of claim 12, wherein the instructions cause:
receiving, at the web browser, an invocation of the API from the website, the API allowing the website to access information stored on the computing device.

14. The non-transitory computer-readable medium of claim 12, wherein the instructions cause:
allowing, through the web browser, the website to access contacts information stored on the computing device through the API.

15. A system comprising:
one or more processors; and
a computer-readable medium including one or more sequences of instructions which,
when executed by the one or more processors, causes:
receiving, at a web browser application executing on a computing device, a certificate associated with a push notification provider;
determining, by the web browser, that the certificate is valid;
in response to the determination, presenting a prompt on a user interface of the web browser requesting that a user approve receiving push notifications from the push notification provider;
receiving approval from the user for the website to send push notifications to the computing device; and
in response to receiving approval from the user, transmitting, from the web browser to the push notification provider, a device token that identifies the computing device to a push notification service.

16. The system of claim 15, wherein the certificate indicates that the push notification provider is trusted to send push notifications to user devices.

17. The system of claim 15, wherein the instructions cause:
receiving, at an operating system service of the computing device, a push notification from a push notification server; and
displaying the push notification on a user interface of an operating system of the computing device.

18. The system of claim 15, wherein the instructions cause:
downloading, by the web browser, a webpage of the website;
obtaining a network address from the webpage; and
downloading the certificate based on the network address.

19. A system comprising:
one or more processors; and
a computer-readable medium including one or more sequences of instructions which,
when executed by the one or more processors, causes:
receiving, at a web browser application executing on a computing device, a certificate associated with a website;
determining, by the web browser, that the certificate is valid;
in response to the determination, presenting a prompt on a user interface of the web browser, the prompt requesting that a user allow the website to access a web browser API for accessing information on the computing device;
receiving approval from the user for the website to access the API; and
in response to receiving approval from the user, sending the website approval to access the API.

20. The system of claim 19, wherein the instructions cause:
receiving, at the web browser, an invocation of the API from the website, the API allowing the website to access information stored on the computing device.

21. The system of claim 19, wherein the instructions cause:
allowing, through the web browser, the website to access contacts information stored on the computing device through the API.
